(19) United States
(12) Patent Application Publication
(10) Pub. No.: US 2013/0068566 A1
(43) Pub. Date: Mar. 21, 2013

(54) SUPPORTING ASSEMBLY AND SUPPORTING DEVICE FOR USE THEREIN

(71) Applicants: Willem HEIJNS, Kinderdijk (NL); Arnout Antoine BREEVAART, Nieuwerkerk aan de IJssel (NL); Berend TIMMERMAN, Spijkenisse (NL)

(72) Inventors: Willem HEIJNS, Kinderdijk (NL); Arnout Antoine BREEVAART, Nieuwerkerk aan de IJssel (NL); Berend TIMMERMAN, Spijkenisse (NL)

(73) Assignee: THYSSENKRUPP ACCESSIBILITY BV, Krimpen aan de IJssel (NL)

(21) Appl. No.: 13/621,297

(22) Filed: Sep. 17, 2012

(30) Foreign Application Priority Data
Sep. 20, 2011 (EP) 11182074.2

(51) Int. Cl. B66B 9/08

(52) U.S. Cl. 187/201

(57) ABSTRACT

Supporting assembly comprising a staircase with treads having tread nosing's and a supporting device with a rail mounted at one of the sides of said staircase, the supporting device comprising a carriage movable along the rail, a carriage drive for moving the carriage along the rail between an upper part of the staircase and a lower part of the staircase, a support bracket mounted on the carriage to support a person walking on the staircase and a control system to control the supporting device. The tread line connects the tread nosing's of the staircase and the rail and the carriage are located near the tread line and a substantially vertical bar extends above the carriage and couples the support bracket to the carriage.

### CROSS-REFERENCE AND PRIORITY CLAIM TO RELATED APPLICATIONS

This application claims priority to European Patent Application No. 11182074.2, filed Sep. 20, 2012, entitled “Supporting assembly and supporting device for use therein” which application is incorporated herein by reference and made a part hereof in its entirety.

### FIELD OF INVENTION

The disclosure firstly relates to a supporting assembly in accordance with the preamble of claim 1.

### BACKGROUND

The discussion below is merely provided for general back-ground information and is not intended to be used as an aid in determining the scope of the claimed subject matter.

An assembly is known from document EP 2092925. The known supporting assembly comprises a rail mounted along a wall at a side of the staircase at the height of the waist of the person walking along the staircase, and the carriage with the support bracket extends in horizontal direction sideways to the rail.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted herein.

The disadvantage of the known supporting assembly is that the carriage is located adjacent the waist of the body of the person walking along the staircase, which is the wider part of the body. This means that the supporting assembly can only be used when the staircase is sufficient wide.

In order to overcome this disadvantage the supporting assembly is characterized according to claim 1. In this way there is a distance between the support bracket and the carriage and the wider part of the body of the person using the support bracket is adjacent the vertical bar and has sufficient room for the person to move. the rail and the carriage are adjacent to the lower part of the legs and feet of the person walking along the staircase, which require less space than the waist, such that the supporting device can also be used in narrower staircases.

Preferably the supporting assembly is devised in accordance with claim 2. In this way, the carriage does not interfere with the person walking along the staircase.

Preferably the supporting assembly is devised in accordance with claim 3. In this way the supporting assembly can also be used on a narrow staircase.

In accordance with a further embodiment the supporting assembly is devised according to claim 4. In this way, in situations where the walking ability of the user changes for the worse and the user cannot walk the staircase anymore, a chair of a stair lift can replace the support bracket and the vertical bar.

In accordance with a further embodiment, the supporting assembly is devised according to claim 5. In this way, the support bracket maintains a desired height above the tread line and/or desired inclination relative to the horizontal plane when the carriage moves along a curved rail at the side of a staircase that has curves. The changes in height of the rail above the tread line and the changing inclination angle of the rail now can be compensated during movement of the carriage along the rail.

In accordance with a further embodiment, the supporting assembly is according to claim 6. In this way, the control system can maintain the support bracket at the desired height and desired inclination independently of the actual shape of the staircase and of the rail, so that this height and inclination always have the correct values and need not be set during installation and/or use of the device.

In accordance with a further embodiment, the supporting assembly is according to claim 7. In this way, the control system can maintain the support bracket at the desired height and desired inclination based on a one time measurement during installation, and no real time sensors are required to detect the height or inclination of the support bracket. This leads to a less complicated assembly.

In accordance with a further embodiment, the supporting assembly is devised according to claim 8. In this way, the person walking along the staircase (especially downwards) can see where to put his feet, so that the risk of falling is further reduced.

The invention also relates to a supporting assembly in accordance with claim 9. The support bracket known from document EP 2092925 comprises pipes that the user must grip with his hands. The disadvantage of this known support bracket is that the user needs full use of his hands and must stabilise himself by gripping the pipes. In case that his hands are not strong enough or in case that the person stumbles he will lose his support and there is a risk that the person falls down the staircase. A further disadvantage is that when walking upwards the support bracket is in front and against the users belly, which can be very uncomfortable.

These disadvantages are overcome with the support bracket as defined in claim 9. Now, the person walking downwards has the support bracket on both sides of his body and the coupling bar in front of him, whereby the armrests support his arms. In case of stumbling, the support bracket supports the arms and the coupling bar prevents falling forward so that falling down the stairs is prevented. The person walking upwards also leans on the armrests and the coupling bar prevents falling backwards in case of stumbling. The location of the hinge ensures that the hinge supports the support bracket in a stable manner.

In accordance with a further embodiment the supporting assembly is devised according to claim 10. In this way, a hand grasps the handle of the armrest while the hand maintains its natural position on the armrest. In case of stumbling, a person grasps his hand around something and the handles at the ends of the armrests are suitable for this. A person walking up or down the staircase with his arms on the armrests has the handles near his hands so that in case of stumbling he grasps the handles while maintaining support of the armrests.

In accordance with a further embodiment, the supporting assembly is according to claim 11. In this way, a person pressing the dead man's handle for activating an upward or downward movement of the carriage, has to press the dead man's handle, for example with his thumb. This ensures that in case of stumbling, he automatically removes the pressure of his thumb on the dead man's handle and the movement of the carriage with support bracket stops so that the risk of falling is reduced.

In accordance with a further embodiment, the supporting assembly is according to claim 12. In this way, the fingers of a hand grasping a handle at the end of the converging armrest are located at some distance from the largest width of the armrest so that movement of a support bracket closely along a wall bordering the staircase does not lead to scraping of the fingers along said wall.

In accordance with a further embodiment, the supporting assembly is devised according to claim 13. In this way, the rotation of the support bracket around the rotation axis of the hinge causes the support bracket to rotate between a horizontal plane whereby it is located fully (substantially centrally) above the staircase and a vertical plane whereby it is located substantially above the rail. The armrest at the side facing away from the hinge thereby rotates in such a way that a person positioned at the underside of the staircase and wanting to move upwards remains free from this armrest while the support bracket rotates around the hinge.

In accordance with a further embodiment, the supporting assembly is devised according to claim 14. In this way, the support bracket forms a stable support for the person walking along the staircase.

In accordance with yet a further embodiment the supporting assembly is devised according to claim 15. In this manner, the support bracket brings the person walking upwards on the staircase in a proper walking position so that the support bracket also can be used for improving the walking posture of said person.

In a second aspect the invention relates to a supporting device for use in a supporting assembly according to the present invention.

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

### BRIEF DESCRIPTION OF THE DRAWINGS

Hereinafter the invention will be elucidated while referring to the drawings, in which:

FIG. 1 illustrates a side view of a first embodiment of the supporting assembly according to the present invention;

FIG. 2 illustrates an embodiment of a support bracket in a first position;

FIG. 3 illustrates the support bracket of FIG. 2 in a second position;

FIG. 4 illustrates the support bracket of FIG. 2 in a third position;

FIG. 5 shows a second embodiment of the supporting assembly while being used by a person descending the staircase, in a perspective view;

FIG. 6 shows the supporting assembly of FIG. 5 while being used by a person ascending the staircase, in a perspective view; and

FIG. 7 shows the supporting assembly of FIG. 5 in a top plan view while being used by a person ascending the staircase.

### DETAILED DESCRIPTION

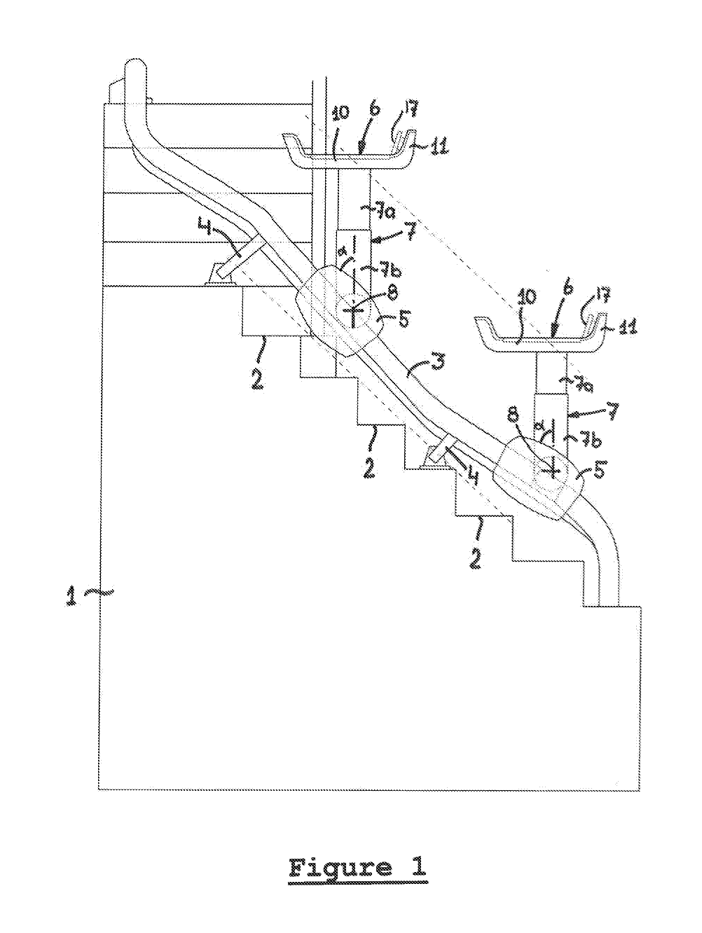

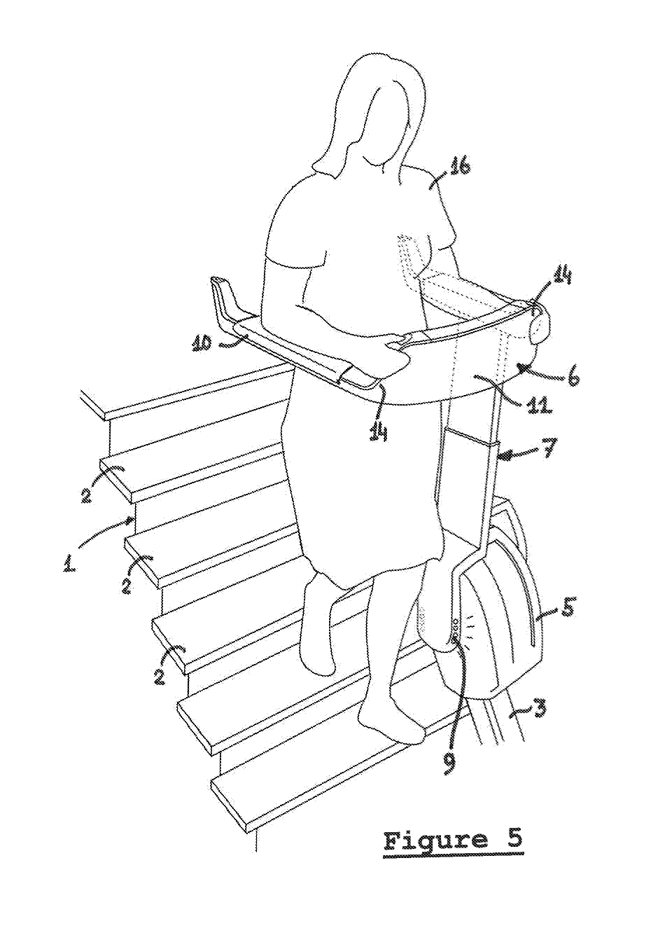

Referring firstly to FIG. 1, a supporting assembly is illustrated comprising a staircase 1 with treads 2 and two corners and a first embodiment of a supporting device. Said supporting device basically comprises a rail 3 with curved sections mounted above one of the sides of said staircase 1. The rail 3 may be mounted to the staircase 1 using legs 4 (as illustrated), but it is conceivable too to mount it to a wall bordering the staircase 1. A second embodiment of the supporting device is shown in FIGS. 5-7. The major difference between the first and the second embodiment is that the rail 3 and the staircase 1 are straight and the staircase 1 has no corners.

A carriage 5 is movable along the rail 3 (in FIG. 1 the carriage is illustrated in two different positions) driven by a carriage drive (not illustrated in detail; e.g. an electric motor) between an upper part of the staircase and a lower part of the staircase 1.

A support bracket 6 is mounted on the carriage 5 to support a person walking on the staircase 1. Finally the supporting assembly comprises a control system (not illustrated in detail; it may be housed within the carriage 5, the support bracket 6 or any other convenient part of the supporting assembly) to control the supporting assembly.

The rail 3 and the carriage 5 are located immediately above the treads 2 of the staircase 1 at one side of the staircase 1. Each tread 2 has a tread nosing and a tread line follows the tread nosing's in the centre of the staircase 1. The rail 3 is immediately above the tread line. A substantially vertical bar 7 is provided extending above the carriage 5 at one side of the staircase for coupling the support bracket 6 to the carriage 5, such that, notwithstanding the low position of the carriage 5, the support bracket 6 is located sufficiently high for comfortably supporting a person walking up or down the staircase 1.

Preferably the supporting assembly according to the present invention is devised in such a manner that a connecting point 8 of the vertical bar 7 to the carriage 5 is a widest part of the carriage 5 and this widest part of the carriage 5 is less than 0.8 m above the tread line and preferably less than 0.5 meter above the tread line and most preferably less than 0.4 meter above the tread line.

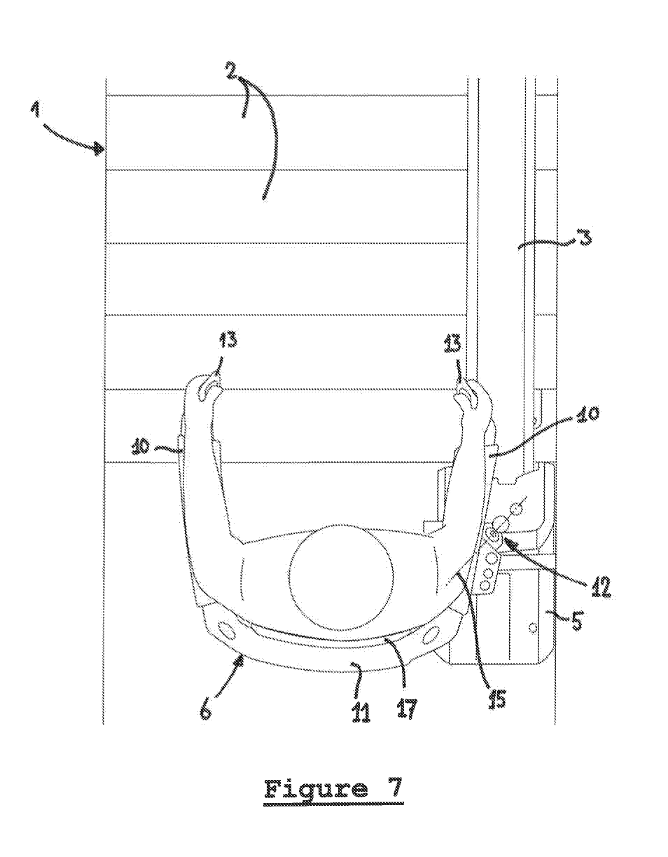

As illustrated best in FIG. 7, at least part of the support bracket 6 is located vertically above the carriage 5.

In an embodiment not illustrated, the carriage 5 is suitable for mounting a stair lift chair. Preferably, then, the bar 7 is detachable from the carriage 5 previous to mounting said stair lift chair.

In the embodiment of the supporting assembly illustrated in FIG. 1, the length of the vertical bar 7 is adjustable (for example by providing two telescoping bar parts 7a and 7b). A bar drive (not illustrated; e.g. driven by an electric motor) may be provided for adjusting the length of the vertical bar 7 when the carriage 5 moves along the rail 3 as shown for the first embodiment wherein said rail 3 does makes curves.

Additionally, or as an alternative, it is possible that the connecting point 8 is a hinge 8 connecting the vertical bar 7 (or its lower part 7b) to the carriage 5, wherein a hinge drive (shown neither; e.g. an electric motor) is provided for adjusting the angle a between the vertical bar 7 and the carriage 5 when the carriage moves along the rail 3 and said rail makes curves, as a result of which the inclination of the carriage varies along said rail. (In case of the second embodiment as illustrated in FIGS. 5-7 the vertical bar 7 has during movement of the carriage 5 a fixed length and a fixed inclination relative the carriage 5).

The first embodiment of the supporting assembly may comprise a first sensor (not illustrated) for detecting the height of the support bracket 6 above the treads 2 or the tread line and/or a second sensor (not illustrated) for detecting the angle between the support bracket 6 and a horizontal plane, wherein based on the sensor information of the first sensor and/or the second sensor the control system activates the bar drive and/or the hinge drive for maintaining the support bracket 6 at a constant height above the tread line and at a constant inclination (indicated in FIG. 1 in which in the upper position of the carriage 5 the bar 7 has a larger length and angle α between the bar 7 and carriage 5 is smaller than in the lower position of the carriage).

In an alternative embodiment of the supporting assembly it comprises a single sensor for detecting the (longitudinal) position of the carriage 5 along the rail 3, wherein the control system further comprises a memory that contains specified settings of the bar drive and/or the hinge drive in dependence of the position of carriage along the rail 3. The control system automatically sets the bar drive and/or the hinge drive corresponding with said specified settings in dependence of the position of the carriage along the rail 3 as detected by the sensor.

Preferably the carriage 5 is provided with lamps 9 (FIG. 5) that can illuminate the treads 2 adjacent and/or below the carriage 5.

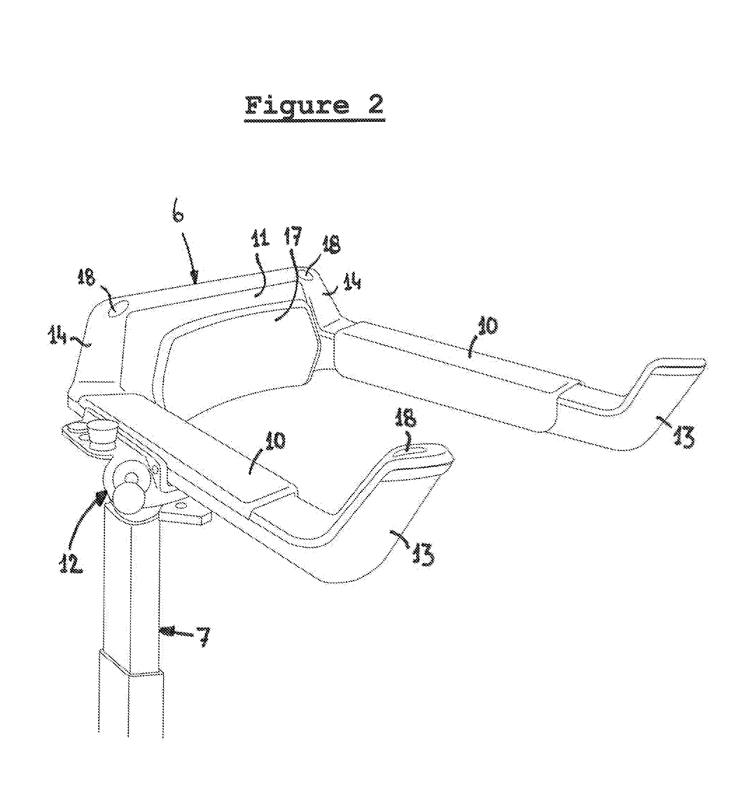

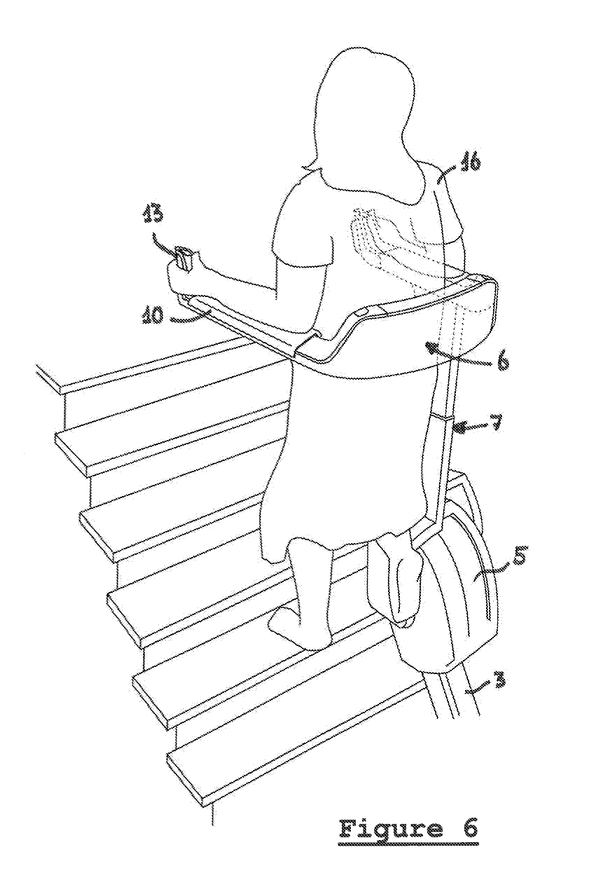

As shown best in FIG. 2 the support bracket 6 comprises two arm rests 10 (located at both sides above the staircase 1 as illustrated in FIG. 7) forming a U-shape together with a coupling bar 11 that connects the arm rests 10 and that faces the downward direction of the staircase 1 (as shown best in FIGS. 5 and 6) and leaving an opening there between that faces the upward direction of the staircase 1.

The support bracket 6 is connected to the carriage 5 (through bar 7) by a hinge 12 (see FIGS. 2-4 and 7) which preferably is located in a central region of one of the arm rests 10.

The arm rests 10 at both ends are provided with an upwardly extending handle 13, 14 (see FIG. 2) that has a height approximately equal to the width of a hand of a user or that is at least 60 millimetres. Preferably each upwardly extending handle 13,14 has a top provided with a dead man's handle 18 to activate the upward or downward movement of the carriage 5, wherein preferably two dead man's handles 18, belonging to different ones of the arm rests 10, need to be activated simultaneously for activating the upward or downward movement of the carriage.

When ascending the staircase (FIG. 6) a user 16 will grip the handles 13, and when descending the staircase (FIG. 5) the user will grip handles 14.

As seen in a horizontal plane (see FIG. 7), the ends of the armrests 10 facing the upward direction of the staircase (i.e. the ends provided with the handles 13) converge towards the centre of the opening between the armrests 10.

In the illustrated embodiment of the supporting assembly, the hinge 12 has an axis of rotation 15 (see FIG. 7) extending downwards at an angle of approximately 45 degrees with a horizontal plane and at an angle of approximately 45 degrees with the rail 3 in the downward direction towards the centre of the staircase 1.

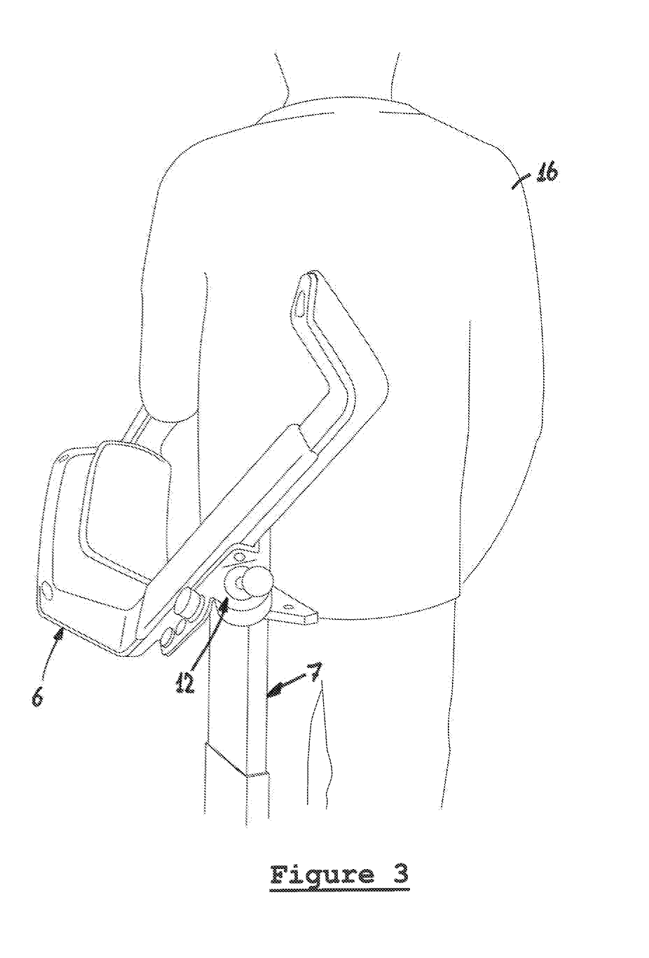

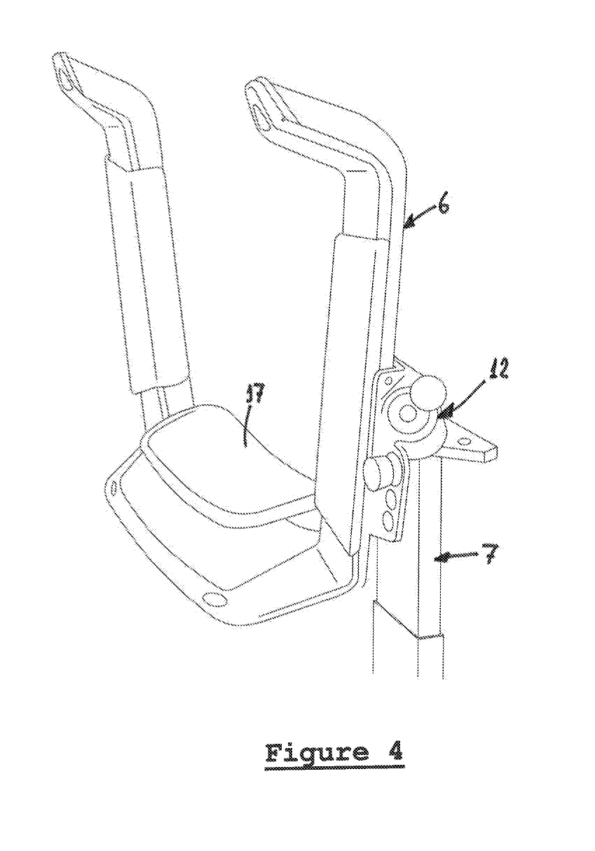

Such an axis of rotation 15 allows the support bracket 6 to be rotated from the operative (horizontal) position of FIG. 2, through an intermediate position illustrated in FIG. 3 and to a rest position shown in FIG. 4 in which it is positioned in a vertical plane parallel to the rail 3 (for example close to a wall bordering the staircase). The special position of the axis of rotation 15 allows the support bracket 6 to disengage a user 16 (see FIG. 3) without the need for said user to manipulate its body in an awkward manner.

The support bracket 6 may be a unitary part. The coupling bar 11 may be provided with an adjustable back support 17 for supporting the back of a person walking upwards along the treads of the staircase. In this way persons needing exercise for medical reasons can use the supporting assembly for improving their walking.

Several embodiments of the supporting assembly are disclosed below, with illustrative references to some parts of the figures (not intended to be limiting):

### Embodiment 1

Supporting assembly comprising a staircase (1) with treads (2) having tread nosing's and a supporting device (6) with a rail (3) mounted at one of the sides of said staircase, the supporting device comprising a carriage (5) movable along the rail, a carriage drive for moving the carriage along the rail between an upper part of the staircase and a lower part of the staircase, a support bracket mounted on the carriage to support a person (16) walking on the staircase and a control system to control the supporting device, characterized in that a tread line connects the tread nosing's of the staircase (1) and the rail (3) and the carriage (5) are located near the tread line, and a substantially vertical bar (7) extends above the carriage and couples the support bracket (6) to the carriage.

### Embodiment 2

Supporting assembly according to embodiment 1, wherein the carriage (5) has a widest part (8) that extends above the treads (2), and the widest part of the carriage is less than 0.8 m above the tread line and preferably less than 0.5 meter above the tread line and most preferably less than 0.4 meter above the tread line.

### Embodiment 3

Supporting assembly according to any of the previous embodiments, wherein at least part (10) of the support bracket (6) is located vertically above the carriage (5).

### Embodiment 4

Supporting assembly according to any of the previous embodiments, wherein the carriage (5) is suitable for mounting a stair lift chair.

### Embodiment 5

Supporting assembly in accordance with one of the previous embodiments, wherein the length of the vertical bar (7a,7b) is adjustable and wherein a bar drive is provided for optionally adjusting the length of the vertical bar when the carriage (5) moves along the rail (3), and/or wherein a first hinge (8) is provided connecting the vertical bar to the carriage and a wherein a first hinge drive is provided for optionally adjusting the angle (α) between the vertical bar and the carriage when the carriage moves along the rail.

### Embodiment 6

Supporting assembly in accordance with embodiment 5, further comprising a first sensor for detecting the height of the support bracket (6) above the tread line and/or a second sensor for detecting the angle between the support bracket and a horizontal plane, wherein based on the sensor information of the first sensor and/or the second sensor the control system activates the bar drive and/or the first hinge drive.

### Embodiment 7

Supporting assembly in accordance with embodiment 5, comprising a sensor for detecting the position of the carriage (5) along the rail (3), wherein the control system further comprises a memory that contains specified settings of the bar drive and/or the hinge drive in dependence of the position of carriage along the rail, such that the control system sets the bar drive and/or the first hinge drive corresponding with said specified settings in dependence of the position of the carriage as detected by the sensor.

### Embodiment 8

Supporting assembly in accordance with one of the previous embodiments, wherein the carriage (5) is provided with lamps (9) for illuminating the treads (5) adjacent and/or below the carriage.

### Embodiment 9

Supporting assembly in accordance with one of the previous embodiments, wherein the support bracket (6) comprises two arm rests (10) at both sides of the staircase (1) and a coupling bar (11), together forming a U-shape with an opening that faces the upward direction of the staircase (1), and wherein the support bracket is connected to the substantially vertical bar (7) by a second hinge (12), and preferably the second hinge is located in a central region of one of the arm rests (10).

### Embodiment 10

Supporting assembly in accordance with embodiment 9, wherein the end of an arm rest (10) has an upwardly extending handle (13,14) that has a height approximately equal to the width of a hand of a user or that is at least 60 millimetres.

### Embodiment 11

Supporting assembly in accordance with embodiment 10, wherein the upwardly extending handle (13,14) has a top provided with a dead man's handle (18) to activate upward or downward movement of the carriage (5), and wherein preferably two dead man's handles, belonging to different arm rests (10), need to be activated simultaneously for activating the upward or downward movement of the carriage.

### Embodiment 12

Supporting assembly in accordance with one of the embodiments 9-11, wherein, as seen in a horizontal plane, the ends (13) of the armrests facing the upward direction of the staircase converge towards the centre of the opening.

### Embodiment 13

Supporting assembly in accordance with one of the embodiments 9-12, wherein the second hinge (12) has an axis of rotation (15) extending downwards at an angle of approximately 45 degrees with a horizontal plane and at an angle of approximately 45 degrees with the rail (3) in the downward direction towards the centre of the staircase (1).

### Embodiment 14

Supporting assembly in accordance with one of the embodiments 9-13, wherein the support bracket (6) is a unitary part.

### Embodiment 15

Supporting assembly in accordance with one of the embodiments 9-14, wherein the coupling bar (11) is provided with a back support (17) for supporting the back of a person walking upwards along the treads (2) of the staircase and wherein preferably the distance between the coupling bar and the back support is adjustable.

### Embodiment 16

Supporting device for use in a supporting assembly according to any of the previous embodiments.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

The invention is not limited to the embodiments described which may be varied widely within the scope of the invention as defined by the appending claims. For instance in the shown embodiment, there is a carriage that moves along a single rail and the invention can also be applied to embodiments whereby the carriage moves along two rails.

1. Supporting assembly comprising:
a staircase with treads having tread nosing's; and
a supporting device (6) with a rail mounted at one of the sides of said staircase, the supporting device comprising:
a carriage movable along the rail,
a carriage drive for moving the carriage along the rail between an upper part of the staircase and a lower part of the staircase,
a support bracket mounted on the carriage to support a person walking on the staircase and a control system to control the supporting device,
wherein
a tread line connects the tread nosing's of the staircase and
the rail (and the carriage are located near the tread line, and
a substantially vertical bar extends above the carriage and couples the support bracket to the carriage.

2. Supporting assembly according to claim 1, wherein
the carriage has a widest part that extends above the treads, and
the widest part of the carriage is less than 0.8 m above the tread line.

3. Supporting assembly according to claim 1, wherein at least part of the support bracket is located vertically above the carriage.

4. Supporting assembly according to claim 1, wherein the carriage is suitable for mounting a stair lift chair.

5. Supporting assembly in accordance with claim 1, wherein:
the length of the vertical bar is adjustable and wherein a bar drive is provided for optionally adjusting the length of the vertical bar when the carriage moves along the rail, and/or
a first hinge is provided connecting the vertical bar to the carriage and wherein a first hinge drive is provided for optionally adjusting the angle between the vertical bar and the carriage when the carriage moves along the rail.

6. Supporting assembly in accordance with claim 5, further comprising:
a first sensor for detecting the height of the support bracket above the tread line and/or
a second sensor for detecting the angle between the support bracket and a horizontal plane,
wherein based on the sensor information of the first sensor and/or the second sensor the control system activates the bar drive and/or the first hinge drive.

7. Supporting assembly in accordance with claim 5, comprising a sensor for detecting the position of the carriage along the rail, wherein the control system further comprises a non-transitory computer readable memory that includes specified settings of the bar drive and/or the hinge drive in dependence of the position of carriage along the rail, such that the control system sets the bar drive and/or the first hinge drive corresponding with said specified settings in dependence of the position of the carriage as detected by the sensor.

8. Supporting assembly in accordance with claim 1, wherein the carriage is provided with lamps for illuminating the treads adjacent and/or below the carriage.

9. Supporting assembly in accordance with claim 1, wherein the support bracket comprises two arm rests at both sides of the staircase and a coupling bar, together forming a U-shape with an opening that faces the upward direction of the staircase, and wherein the support bracket is connected to the substantially vertical bar by a second hinge.

10. Supporting assembly in accordance with claim 9, wherein the end of an arm rest has an upwardly extending handle that has a height approximately equal to the width of a hand of a user or that is at least 60 millimetres.

11. Supporting assembly in accordance with claim 10, wherein the upwardly extending handle has a top provided with a dead man's handle to activate upward or downward movement of the carriage.

12. Supporting assembly in accordance with claim 9, wherein, as seen in a horizontal plane, the ends of the armrests facing the upward direction of the staircase converge towards the centre of the opening.

13. Supporting assembly in accordance with claim 9, wherein the second hinge has an axis of rotation extending downwards at an angle of approximately 45 degrees with a horizontal plane and at an angle of approximately 45 degrees with the rail in the downward direction towards the centre of the staircase.

14. Supporting assembly in accordance claim 9, wherein the support bracket is a unitary part.

15. Supporting assembly in accordance with claim 9, wherein the coupling bar is provided with a back support for supporting the back of a person walking upwards along the treads of the staircase.

16. Supporting device for use in a supporting assembly according to claim 1.

17. Supporting assembly according to claim 2, wherein the widest part of the carriage is less than 0.5 meter above the tread line.

18. Supporting assembly according to claim 2, wherein the widest part of the carriage is less than 0.4 meter above the tread line.

19. Supporting assembly according to claim 9, wherein the second hinge is located in a central region of one of the arm rests.

20. Supporting assembly of claim 11, wherein two dead man's handles, belonging to different arm rests, need to be activated simultaneously for activating the upward or downward movement of the carriage.

21. Supporting assembly of claim 15, wherein the distance between the coupling bar and the back support is adjustable.
